(19) United States
(12) Patent Application Publication
(10) Pub. No.: US 2012/0119083 A1
(43) Pub. Date: May 17, 2012

(54) Ion Trap Device

(75) Inventors: Kei Kodera, Kyoto (JP); Makoto Hazama, Kyoto (JP); Shinichi Iwamoto, Kyoto (JP); Sadanori Sekiya, Kyoto (JP)

(73) Assignee: SHIMADZU CORPORATION, Kyoto-shi, Kyoto (JP)

(21) Appl. No.: 13/262,214

(22) PCT Filed: Mar. 30, 2009
(86) PCT No.: PCT/JP2009/001442

§ 371 Date: Nov. 21, 2011

(51) Int. Cl. H01J 49/42

(52) U.S. Cl. 250/290

(57) ABSTRACT

Ions supplied in the form of a pulse are introduced into an ion trap through an ion entering orifice while a rectangular voltage of a frequency higher than the frequency at which the best trap is accomplished is applied to a ring electrode from a trap voltage generating unit. With this, since a well of a pseudo ion potential is formed in a radial direction in the ion trap, the spread of ions of low m/z values introduced previously is suppressed. A part of ions is introduced into the ion trap, and thereafter the frequency of the rectangular voltage applied to the ring electrode is lowered stepwise to the frequency at which the best trap is accomplished. As a result, the ions of the low m/z values introduced previously can be efficiently trapped, and introduction of ions of high m/z values reaching the ion trap later is not hindered. Consequently, ions of a wide range of m/z values can be trapped in the ion trap with high efficiency

### FIELD OF TECHNOLOGY

The present invention relates to an ion trap device having an ion trap that uses an AC electrical field for confining ions and used in ion trap mass spectrometers, ion trap time-of-flight mass spectrometers and the like.

### BACKGROUND ART

Apparatuses that use ion traps that employ an AC electrical field to trap (confine) ions and used with mass spectrometers have been known in the art. A typical ion trap is the so-called 3-dimensional quadrupole ion trap which comprises a substantially annular ring electrode and a pair of end cap electrodes which are disposed to sandwich the ring electrode. With such previous ion traps, a sine-wave RF voltage is applied to the ring electrode to form a trapping electrical field in the space surrounded by the electrode. The trapping electrical field causes the ions to oscillate as they are confined. A recent development is the so-called digital ion trap (DIT) wherein a rectangular voltage, instead of a sine-wave voltage, is applied to the ring electrode to confine the ions (see Patent Literature 1 and 2 and Non-Patent Literature 1).

The afore-described ion trap can be used in various ways. One use is where various ions that are generated from an ion source are temporarily accumulated, are imparted with kinetic energy, and released all at once and introduced into, for example, a time-of-flight mass spectrometer. Another use is where a collision induced dissociation gas such as argon is introduced into an ion trap to cause the ions trapped by the ion trap to collide with the collision induced dissociation gas to promote cleaving and generate product ions. The ion traps can also be used in mass spectrometers wherein various ions are accumulated in an ion trap, and ions having a predetermined mass/charge ratioare released from the ion trap and detected by an external detector.

In any event, except for the case where specimen molecules are ionized inside the ion trap, it is necessary to introduce ions that are generated by an external ion source into an ion trap and to temporarily trap the ions within the ion trap. Ordinarily, the ions are introduced into an ion trap from the outside through an ion introduction orifice that is formed substantially at the center of an inlet-side end cap electrode.

What is important for improving the analysis sensitivity and analysis accuracy of mass spectrometers that use an ion trap is to increase the trapping efficiency with which the ion trap traps the ions that are generated by an external ion source and introduced into the ion trap. Confining the ions within an ion trap requires the application of an appropriate RF voltage (rectangular RF voltage in the case of digital ion traps) to the ring voltage [sic]. However, the application of a RF voltage to the ring voltage [sic] creates an RF electrical field that hinders the entry of the ions into the ion trap. Furthermore, since the state of the RF electrical field changes during a single cycle of a RF voltage, the ion trapping efficiency depends on the phase of the RF voltage as the ions enter the ion trap and also on the mass/charge ratio of the entering ions.

For example, with a previous mass spectrometer described in Patent Literature 3, ions falling within a specific mass/charge ratio range are introduced into an ion trap starting first with ions with a low mass/charge ratio and sequentially moving on to ions with higher mass/charge ratios (i.e., by scanning the mass/charge ratio). Furthermore, to increase the trapping efficiency of ions that fall within a broad mass/charge ratio range, the amplitude or the frequency of the RF voltage that is applied to the ring electrode is suitably changed depending on the mass/charge ratio of the ions that are intended to enter the ion trap. However, to create an optimum condition for trapping ions, a RF voltage has to be applied to the ring electrode as the ions enter the ion trap, but the very application of the RF voltage also impedes the introduction of the ions into the ion trap, creating a dilemma in improving the ion trapping efficiency.

With the mass spectrometers described in Patent Literature 2 and Patent Literature 4, the application of a RF voltage to the ring electrode is temporarily suspended when the ions are entering the ion trap, and the application of the RF voltage to the ring electrode is quickly resumed after the ions have entered the ion trap. With this method, the entry of the ions into the ion trap is not impeded by a RF electrical field, and the ion introduction efficiency is increased. If the kinetic energy of the ions that are introduced can be kept sufficiently low, ions can be trapped with good efficiency.

In this case, there is no need to scan the mass/charge ratio of the ions that enter the ion trap as is the case with the apparatus described in Patent Literature 3. Instead, various ions having a broad range of mass/charge ratios can be introduced together into the ion trap, allowing various ions having a broad range of mass/charge ratios to be trapped by the ion trap in a relatively short amount of time. However, even with this method, there is a tendency for the trapping efficiency to decrease especially with ions having a low mass/charge ratio. There is a strong need for an efficient method for trapping ions having a broad range of mass/charge ratios.
Patent Literature 1: Japanese Unexamined Patent Application Publication (Translation of PCT Application) No. 2003-512702
Patent Literature 2: Unexamined Patent Application Publication No. 2008-282594
Patent Literature 3: Unexamined Patent Application Publication No. 11-120956
Patent Literature 4: Unexamined Patent Application Publication (Translation of PCT Application) No. 2002-502097
Non-Patent Literature 1: Furuhashi, Takeshita, Ogawa, Iwamoto, “Development of a Digital Ion Trap Mass Spectrometer,” Shimadzu Review (Shimadzu Hyouron), editorial staff of Shimadzu Review, Mar. 31, 2006, vol. 62, issues 3/4, pp. 141-151

### DISCLOSURE OF THE INVENTION

### Problems to Be Solved by the Invention

The present invention was made in light of the afore-described problems, and it is the primary object of the present invention to provide an ion trap device that can trap ions having a broad range of mass/charge ratios with a high trapping efficiency.

### Means for Solving the Problems

To solve the afore-described problems, an ion trap device according to the present invention includes: an ion supply source for supplying ions in the form of a pulse; and an ion trap that uses an electrical field that is formed in a space surrounded by a plurality of electrodes to trap ions that are supplied by the ion supply source; and further comprising:

(a) a voltage applying means for applying an AC voltage to at least one of a plurality of electrodes constituting the ion trap so as to trap the ions in the ion trap; and

(b) a control means that controls the voltage applying means so that immediately after the introduction into the ion trap of ions that are supplied in the form of a pulse from the ion supply source while applying an AC voltage having a predetermined first frequency to one of a plurality of electrodes, the frequency of the AC voltage is changed within a predetermined amount of time to a second frequency of a lower frequency than the first frequency.

The phrase “immediately after the introduction” as used above does not mean immediately after all ions that are supplied in the form of a pulse from the ion supply source have been introduced into the ion trap but instead means immediately after the introduction into the ion trap of ions that arrive early at the ion trap among the ions that are supplied in the form of a pulse from the ion supply source.

A typical ion trap that is related to the present invention is a 3-dimensional quadrupole ion trap that includes a ring electrode and a pair of end cap electrodes that are disposed to sandwich the ring electrode. In this case, the voltage applying means applies an AC voltage to the ring electrode so that ions are trapped by an electrical field that is formed in the space within the ion trap.

The AC voltage that is applied to the electrodes such as the ring electrode may be a sine-waveRF voltage or a voltage having a pulse waveform shape such as rectangular, triangular or sawtooth. In particular, a rectangular voltage can be generated by using a switching device to switch between two types of voltage values, a low voltage and a high voltage. The frequency of the rectangular voltage can be easily switched by changing the switching frequency of the switching device. For this reason, a rectangular voltage is well suited for an ion trap device according to the present invention wherein a control is implemented to change the frequency of an AC voltage.

With a first mode of the ion trap device according to the present invention, the control means controls the voltage applying means so that the frequency of the AC voltage is switched from a first frequency to a second frequency after a predetermined amount of time. To further explain, with the configuration of the first mode, the frequency of the AC voltage is immediately changed from the first frequency to the second frequency, meaning that the aforesaid predetermined amount of time is substantially zero (i.e., ignoring the time required for switching the frequency).

With a second mode of the ion trap device according to the present invention, the control means controls the voltage applying means so that the frequency is changed in a stepwise manner every one or a plurality of cycles from a first frequency to a second frequency while keeping the amplitude of the AC voltage constant. To further explain, with the second mode, unlike with the afore-described first mode, one or a plurality of intermediate frequencies is provided between the first frequency and the second frequency so that the frequency is reduced in stepwise manner during the aforesaid predetermined amount of time.

In any case, with the ion trap device according to the present invention, an AC voltage having a first frequency is applied to the ring electrode so as to form an AC electrical field within the ion trap while ions that are supplied from an ion supply source are introduced into the ion trap through an ion-entering orifice that is formed, for example, in the inlet-side end cap electrode. Ordinarily, the second frequency is set so that the trapping of ions within the ion trap is optimized or nearly optimized. On the other hand, since the first frequency is set to be higher than the second frequency, a pseudopotential well that is formed during the application of an AC voltage having a first frequency to the ring electrode is shallower than the pseudopotential well that is formed during the application of an AC voltage having a second frequency to the ring electrode. This means that the trapping performance of ions within the ion trap is lower during the application of an AC voltage of a first frequency.

While an AC voltage having a first frequency is being applied to the ring electrode, the Coulomb barrier is lowered, making it easier for ions to enter the ion trap. This means that even if ions are introduced into the ion trap while an AC voltage is being applied to the ring electrode, the electrical field that is formed has almost no detrimental effect on the entry of the ions so long as, the frequency of the AC voltage is high, and an ion introduction efficiency of a comparable level can be achieved as when the application of the AC voltage to the ring electrode is temporarily suspended. When the ions enter the ion trap, the pseudopotential well created by the AC voltage that is applied to the ring electrode is formed in a radial direction within the ion trap. The effect of the pseudopotential on the ions increases as the mass/charge ratio of the ions decreases, and the pseudopotential suppresses the dispersion of ions of a small mass/charge ratio that enter the ion trap. This means that even if the frequency of the AC voltage is reduced so that trapping is performed well, ions with a low mass/charge ratio—which previously would not be trapped easily—are well trapped, consequently improving the trapping efficiency even of ions with a low mass/charge ratio.

Needless to say, it is desirable for both the AC voltage having a second frequency and the AC voltage having a first frequency to satisfy the Mathieu parameters to fit within the stable region of a Mathieu diagram which is described in greater detail below. Reducing the frequency of the AC voltage that is applied to the ring electrode from the first frequency to the second frequency means the same as increasing the value of q, one of the Mathieu parameters, on a Mathieu diagram.

With the afore-described second mode, the ion trapping efficiency can be improved not only in the low mass/charge ratio region but also in the high mass/charge ratio region. This is because even when ions are supplied from an ion supply source in the form of a pulse, ions having a high mass/charge ratio will arrive at the ion-entering orifice of the ion trap at a timing later than ions having a low mass/charge ratio. By reducing the frequency of the AC voltage in a stepwise manner, even the ions that arrive late are made to enter the ion trap with relatively high ion introduction efficiency.

However, if the time interval between the entry into the ion trap of the early arriving ions and the setting of the frequency of the AC voltage to the second frequency is too long, the dispersion of the ions that enter the ion trap becomes too large, resulting in a decrease in the ion trapping efficiency. For this reason, it is necessary to define an appropriate predetermined timing for changing the frequency of the AC voltage from the first frequency to the second frequency. Even though this timing depends on factors such as the spatial distance between the ion supply source and the ion trap and the kinetic energy of the ions (i.e., the flight speed of the ions), the time is generally no more than 100 μs and preferably no more than 50 μs. With the first mode of the present invention, the lower limit value for the predetermined time is 0, and with the second mode of the present invention, the lower limit value for the predetermined time depends on the values of the intermediate frequencies and the number of steps but is generally several microseconds.

If a 3-dimensional quadrupole ion trap is used as the ion trap, the application of an AC voltage to a ring electrode generates an AC noise in the end cap voltage to which a DC voltage is applied. An AC electrical field that is formed near the ion-entering orifice by the noise voltage would impede the entry of ions into the ion trap. Hence, to reduce the effects of the AC electrical field created by noise voltage, with the ion trap device according to the present invention, an opening through which ions pass through is formed on the outside of the end cap electrode where the ion-entering orifice is formed, and an electrical field compensation electrode to which a DC voltage is applied is provided.

The electrical field compensation electrode to which a DC voltage is applied provides a shield against the effects of the AC electrical field that is created by the noise voltage, thus improving the ion introduction efficiency and achieving a high ion trapping efficiency regardless of the mass/charge ratio.

With the ion trap device according to the present invention, the ion trap is generally driven so that ions falling within a broad range of mass/charge ratios can be trapped with a high efficiency. However, it is also possible to use the fact that, under specific driving conditions, the ion trapping efficiency is strongly dependent on the mass/charge ratio to perform selective ion trapping.

For example, with one mode of the ion trap device according to the present invention, in switching the AC voltage immediately after the introduction of the ions into the ion trap, the control means shifts the phase of the AC voltage by 3π/2 if the subject of the analysis is positive ions and by π/2 if the subject of the analysis is negative ions so that ions having specific mass/charge ratios are efficiently trapped by the ion trap.

Ordinarily, when switching the frequency of the A/C voltage, using a phase of 3π/2 in the case of the analysis of positive ions and a phase of π/2 in the case of negative ions optimizes the ion trapping efficiency and also reduces the mass/charge ratio dependency to a relatively low level. In contrast to this, switching the frequency of the AC when the phase is π increases the mass/charge ratio dependency of the ion trapping efficiency and results in a relatively high trapping efficiency for a number of specific mass/charge ratios but also a greatly reduced trapping efficiency for all other mass/charge ratios. This fact can be used to perform a rough selection of ions when trapping the ions with an ion trap. If, for example, this is followed by the selection of precursor ions in the ion trap, the selectivity for them can be increased.

Also, when an electrical field compensation electrode is provided on the outside of an inlet-side end cap electrode as afore-described, a compensation voltage adjustment means is also provided for adjusting the DC voltage that is applied to the electrical field compensation electrode. The compensation voltage adjustment means changes the DC voltage that is applied to the electrical field compensation electrode and increases the potential difference with respect to the DC voltage that is applied to the inlet-side end cap electrode, thereby allowing ions having a specific mass/charge ratio to be efficiently trapped by the ion trap.

If the potential difference between the DC voltage that is applied to the electrical field compensation electrode and the DC voltage that is applied to the inlet-side end cap electrode becomes large, the ions are not decelerated sufficiently enough and will pass beyond the end cap electrodes. If this happens, the ions become susceptible to the effects of the RF noise voltage that is induced in the end cap electrodes by the AC voltage that is applied to the ring electrode, and the trapping efficiency would vary widely depending on the ion's entry timing. The result is an increased mass/charge ratio dependency of the ion trapping efficiency. This also results in a relatively high trapping efficiency to be exhibited for a number of specific mass/charge ratios but also a greatly reduced trapping efficiency for all other mass/charge ratios. This fact can be used to perform a rough selection of ions when trapping the ions with an ion trap.

With the ion trap device according to the afore-described first invention, the behavior of the ions that are about to enter or have just entered the ion trap was controlled by changing the frequency of the AC voltage used for trapping the ions. However, a similar control is also possible by changing the amplitude of the AC voltage. To explain, an ion trap device according to the second invention that was made for solving the afore-described problems includes: an ion supply source for supplying ions in the form of a pulse; and an ion trap that uses an electrical field that is formed in a space surrounded by a plurality of electrodes to trap ions that are supplied by the ion supply source; and further including:

(a) a voltage applying means for applying an AC voltage to at least one of a plurality of electrodes constituting the ion trap so as to trap the ions within the ion trap; and

(b) a control means that controls the voltage applying means so that immediately after the introduction into the ion trap of ions that are supplied in the form of a pulse from the ion supply source while applying an AC voltage having a predetermined first amplitude to one of a plurality of electrodes, the amplitude of the AC voltage is changed within a predetermined amount of time to a second amplitude of a greater amplitude than the first amplitude.

Needless to say and just as with the ion trap device according to the first invention, even with the ion trap device according to the second invention, the amplitude of the AC voltage can be switched from the first amplitude to the second amplitude or, preferably, from the first amplitude to the second amplitude in a stepwise manner with one or a plurality of intermediate amplitudes established between the first and the second amplitudes. Needless to say, if an analog driving method is used wherein the AC voltage is a sine-wave voltage, the amplitude can be continuously increased from the first amplitude to the second amplitude.

### Effects of the Invention

The ion trap device according to the present invention expands the range of mass/charge ratio of ions that can be trapped in an ion trap with a high efficiency as compared to before. Because of this, mass spectrometry that uses the ion trap device according to the present invention expands the range of mass/charge ratio for which mass spectra can be obtained. Furthermore, substances, which could not be previously analyzed by mass spectrometry with sufficient accuracy and sensitivity, can be analyzed by mass spectrometry. Still furthermore, with the ion trap device according to the present invention, ions having a specific mass/charge ratio can be selectively and efficiently trapped.

### BRIEF DESCRIPTION OF THE DRAWINGS

FIG. 1 shows the overall configuration of one embodiment of a MALDI-DIT-MS according to the present invention.

FIG. 2 shows the basic configuration of a 3-dimensional quadrupole ion trap.

FIG. 3 shows a rectangular voltage that is applied to a ring electrode.

FIG. 4 shows one example of a voltage waveform in an ion trap device according to the present invention as the frequency of a rectangular voltage that is applied to a ring electrode is switched before and after the introduction of ions into an ion trap.

FIG. 5 shows a Mathieu diagram that is used to explain the stability condition of solutions to Mathieu equations.

FIG. 6 shows the result of a simulation showing the dispersion of ions as the ions enter an ion trap.

FIG. 7 shows another example of a voltage waveform in an ion trap device according to the present invention as the frequency of a rectangular voltage that is applied to a ring electrode is switched before and after the introduction of ions into an ion trap.

FIG. 8 shows the relationship between the phases of a rectangular waveform and a sine-wave waveform.

FIG. 9 shows the result of a simulation of the ion trapping efficiency of the “ion-introduction-with-RF-application” method according to the present invention and the previous “ion-introduction-without-RF-application” method.

FIG. 10 shows, with regard to the “ion-introduction-with-RF-application” method according to the present invention, the results of a simulation showing the difference in ion trapping efficiency, which depends on the difference in phases when the frequency of RF voltage is switched.

FIG. 11 shows the observed waveform of the noise voltage that was generated in the end cap electrodes when a rectangular RF voltage was applied to the ring electrode.

FIG. 12 shows the result of a simulation of ion trapping efficiency when a noise voltage is generated in the end cap electrodes in the absence of an electrical field compensation electrode.

FIG. 13 shows examples of a voltage waveform in an ion trap device according to the present invention as the amplitude of a rectangular voltage that is applied to a ring electrode is switched just about the time that ions are introduced into the ion trap.

FIG. 14 shows actually measured mass spectra with PMMA600 using the “ion-introduction-without-RF-application” method and the “ion-introduction-with-RF-application” method.

FIG. 15 shows actually measured mass spectra with PMMA4200 using the “ion-introduction-without-RF-application” method and the “ion-introduction-with-RF-application” method.

FIG. 16 shows actually measured mass spectra using the “ion-introduction-with-RF-application” method when switching the frequency of a RF voltage in a stepwise-manner where the number of cycles for repeating the same frequency was changed to 20 cycles.

### DESCRIPTION OF THE NUMERICAL REFERENCES

| | |
|---|---|
| 1. | Sample plate |
| 2. | Sample |
| 3. | Laser reflection unit |
| 4. | Reflection mirror |
| 5. | Aperture |
| 6. | Einzel lens |
| 10. | Ion trap |
| 11. | Ring electrode |
| 12. | Inlet-side end cap electrode |
| 13. | Outlet-side end cap electrode |
| 14. | Trap region |
| 15. | Ion-entering orifice |
| 16. | Ion-exiting orifice |
| 17. | Electrical field compensation electrode |
| 18. | Extraction electrode |
| 19. | Cooling gas supply unit |
| 20. | Ion detector |
| 21. | Conversion dynode |
| 22. | Secondary electron multiplier |
| 30. | Control unit |
| 32. | Trap voltage generating unit |
| 33. | Auxiliary voltage generating unit |
| 34. | Data processing unit |

### BEST MODE OF THE INVENTION

First, the ion trap driving method, which characterizes an ion trap device according to the present invention and is used during introduction of ions, is described, (As described further below, this method is referred to as the “ion-introduction-with-RF-application” method.)

Consider a typical 3-dimensional quadrupole ion trap shown in FIG. 2 that uses a cylindrical coordinate system (r,Z). The ion trap 10 includes one annular ring electrode 11 whose inner peripheral surface is shaped as a hyperboloid of revolution of one sheet andan opposing pair of end cap electrodes 12 and 13 that are disposed to sandwich the ring electrode II and whose inner peripheral surface is shaped as a hyperboloid of revolution of two sheets. The space surrounded by electrodes 11, 12 and 13 becomes a trap region 14. An ion-entering orifice 15 is formed at the center of inlet-side end cap electrode 12. An ion-exiting orifice 16 is formed in the outlet-side end cap electrode 13 along a straight line from the ion-entering orifice 15. Ions that are generated externally pass through the ion-entering orifice 15 and are introduced into the internal space of the ion trap 10. First, consider the case where, as illustrated, a sine-wave RF voltage (hereinafter “RF voltage”), U-V·cos Ωt, is applied to ring electrode 11 as a trapping voltage. This is an ion trap using the so-called analog driving method.

The movement of various ions in the Z-direction and r-direction in the quadrupole field that is formed in the trap region 14 when the aforesaid RF voltage is being applied is described by the following independent equations of motion identified as equations (1) and (2).

d²r/dt²+(Q/mr₀²)(U−V·cos Ωt)r=0 (1)

d²Z/dt²+(2Q/mr₀²)(U−V·cos Ωt)Z=0 (2)

Here, m represents the mass of the ion, Q the ion charge, andr₀ the inscribed radius of the ring electrode 11. By defining a_{z}, aᵣ, q_{z} and qᵣ as indicated by equations (3) and (4),

a_{z}=−2aᵣ=−8U/(m/Q)r₀²Ω² (3)

q_{z}=−2qᵣ=4V/(m/Q)r₀²Ω² (4)

the above equations of motion (1) and (2) can be represented in the form of Mathieu equations shown as equations (5) and (6).

d²r/dζ²+(aᵣ−2qᵣ·cos 2ζ)r=0 (5)

d²Z/dζ²+(a₂−2q_{z}·cos 2ζ)Z≦0 (6)

where ζ=Ωt/2.

The nature of the solution to the above Mathieu equations can be represented using Mathieu parameters a_{z} and qᵣ. The region of (a_{z},q_{z}) that provides a stable solution to equations (1) and (2) is referred to as a stable region.

With a digital ion trap, instead of a sine-wave RF voltage, a rectangular RF voltage is applied to the ring electrode 11, but it is well known that the afore-described relationship still fundamentally applies as is (e.g., see Non-Patent Literature 1). V and U are defined by equations (7) and (8) as follows:

V=2(V₁−V₂)(1−d)d (7)

U=dV₁+(1−d)V₂ (8)

The Mathieu parameters (q and a) are represented by the following equations (9) and (10).

q=4QV/(r₀²Ω²)=QVT²/(π²mr₀²) (9)

a=8QU/(r₀²Q²)=2QUT²/(π²mr₀²) (10)

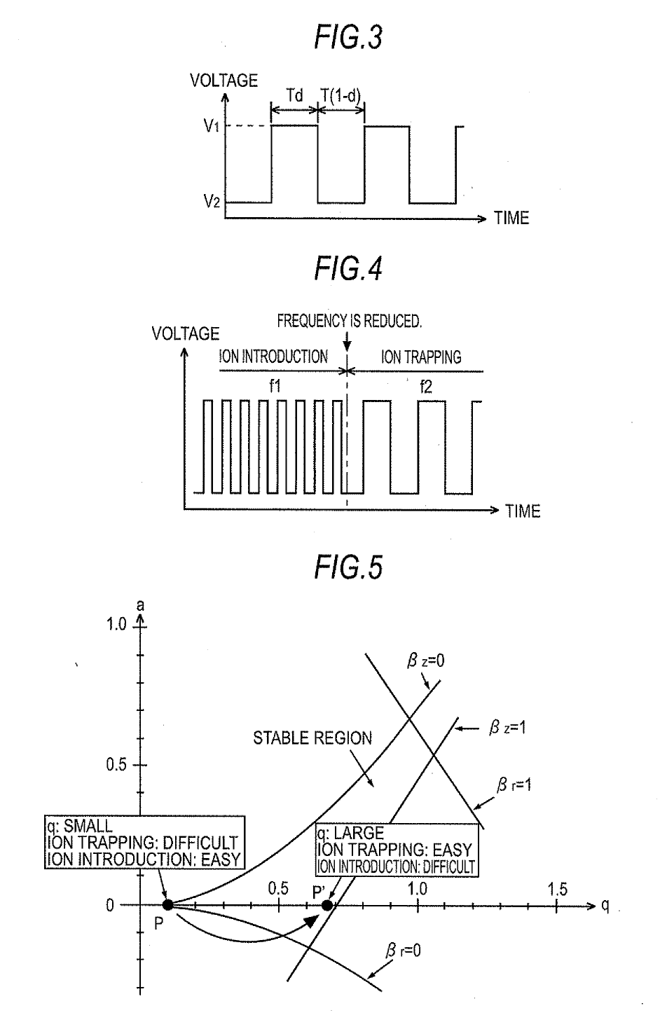

Here, as FIG. 3 shows, V₁, V₂, d and T are parameters that define a rectangular voltage. T represents the period of the rectangular voltage.

FIG. 5 shows a Mathieu diagram that is used for explaining the stability condition of the solutions to the Mathieu equation. In the a-q plane shown in FIG. 5, the region that is enclosed by the solid lines is the stable region, which provides a stable solution to the equations of motion. To further explain, the Mathieu parameters a and q are defined by the mass/charge ratio m/z of the ion. If a particular combination of these values (a and q) is present in the stable region, the ions are confined in the trap region 14, repeatedly oscillating with a specific frequency (secular frequency).

However, it is not the case, in fact, that any ion will unconditionally be trapped as long as parameters a and q are present in the stable region, and only those ions whose kinetic energy is less than the depth of the pseudopotential well that is formed by the RF voltage are trapped. When a rectangular voltage is used as the RF voltage, the depth of the pseudopotential with respect to direction z of the axis of symmetry is represented by equation (11) below.

D₂=(π²/48)qV (11)

The deeper the pseudopotential well, the higher the kinetic energy of ions that can be trapped and the easier it is to trap the ions.

Equation (11) shows that the depth D_{Z} of a pseudopotential is proportional to the value of q. Even if the Mathieu parameters (a and q) of ions that are present in ion trap 10 may be included in the stable region, the ions whose value of q is large are more easily trapped. However, since a large value of q increases the height of the Coulomb barrier that is formed by the RF voltage, the entry of the ions from the outside into the ion trap 10 becomes more difficult. In contrast to this, if the value of q is small for a combination of a and q that is included in the stable region, even though the trapping of the ion becomes relatively more difficult, the entry of the ion into the ion trap 10 becomes easier. In other words, there is a contradictory relationship between the ease of introduction of the ions from the outside into the ion trap 10 and the ease of keeping the ions trapped inside the ion trap 10.

Because of this, the ion trap device according to the present invention uses the fact that the frequency of a rectangular signal can be instantaneously changed with ease. The frequency of the RF voltage is suitably changed between the introduction of the ions into the ion trap and the trapping of the ions within the ion trap so that the efficiency of introduction of the ions and the efficiency in trapping the ions that are introduced are both improved. Specifically, as FIG. 4 shows, the RF voltage is set to a high frequency, f1, to sufficiently reduce the value of q (e.g., q of 0.1 or less for all ions that are introduced) when ions are being introduced into the ion trap 10 through ion-entering orifice 15 and is switched to a low frequency, f2, to increase the value of q (so that the value of q of the ion with the minimum mass/charge ratio among the ions to be trapped approaches q=0.7125 which is the low mass cut off (LMCO) of the stable region) immediately after the ions are introduced into ion trap 10 so as to confine the ions. As FIG. 5 shows, the associated change in (a, q) of the ions on the Mathieu diagram is a movement from P to P′ and is strictly a movement within the stable region.

The previous method of suspending the application of a RF voltage to the ring electrode 11 during the introduction of ions and resuming the application of the RF voltage to the ring electrode 11 as a trapping voltage after the introduction of the ions (hereinafter referred to as the “ion-introduction-without-RF-application” method) was compared against the afore-described method of the present invention (“ion-introduction-with-RF-application” method) wherein a RF voltage with a relatively high frequency is applied to the ring electrode 11 during the introduction of ions and a RF voltage with a relatively low frequency is applied after the introduction of the ions were compared to each other in terms of their performance primarily by simulation. The results are described below.

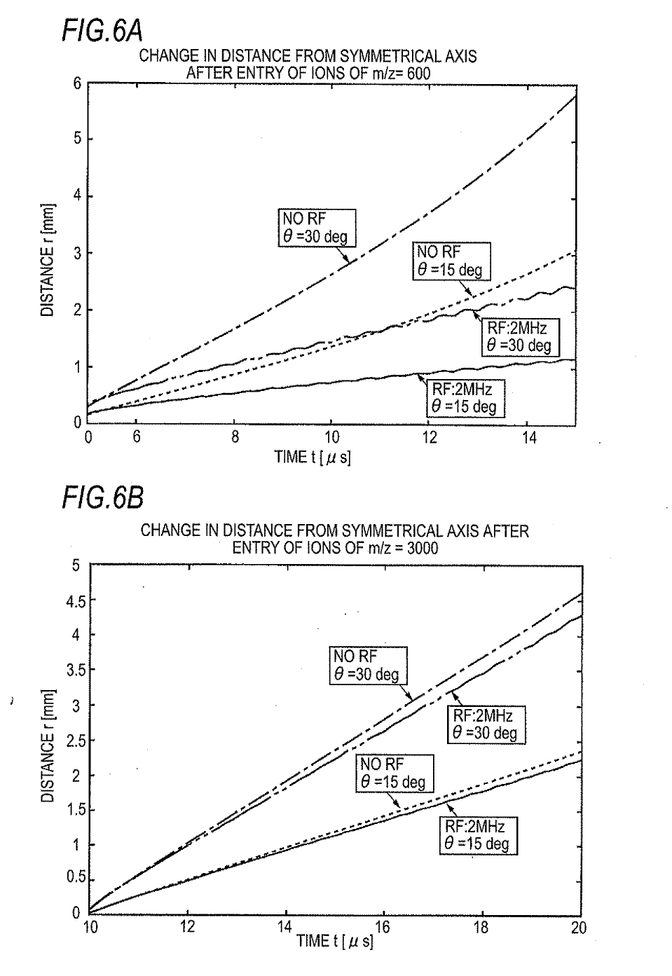

FIG. 6 shows the results of the simulation of the dispersion of the ions within ion trap 10 for ions which entered the ion trap 10 with an initial velocity of 600 m/s and an inclination of 15° or 30° with respect to the axis of symmetry of ring electrode 11. In this figure, the time when an ion enters the ion trap 10 is defined as t=0, and the change in the path (distance from the axis of symmetry) of the ions is depicted for the case where a rectangular RF voltage with a frequency of 2 MHz and a voltage amplitude of 1 kV was either applied or not applied to the ring electrode 11 during the time t=0 to 10 μs. FIG. 6(a) shows the case where the mass/charge ratio m/z of the ion was 600. The figure shows that, as compared to the case where the RF voltage was not applied, the application of a RF voltage to the ring electrode 11 suppresses the change in the distance from the axis of symmetry regardless of whether the angle of incidence was 15° or 30°. FIG. 6(b) shows the case where the mass/charge ratio m/z of the ion was 3000. In this case, it is clear that the dispersion of the ions was hardly affected by whether or not a RF voltage was applied.

This shows that the application of a RF voltage to ring electrode 11 during the introduction of ions suppresses the diffusion in the radial direction particularly for ions with a low mass/charge ratio. The application of a RF voltage to the ring electrode 11 at the time of ion introduction creates a pseudopotential in the radial direction of the ion trap 10 where the ions can fall into. Because the effects of the pseudopotential increase as the mass/charge ratio of an ion decreases, the suppression effect for diffusion in the radial direction becomes particularly pronounced for ions with a low mass/charge ratio. As a result, it is believed that the “ion-introduction-with-RF-application method” improves the ion trapping efficiency in the low mass/charge ratio region as compared to the “ion-introduction-without-RF-application method.”

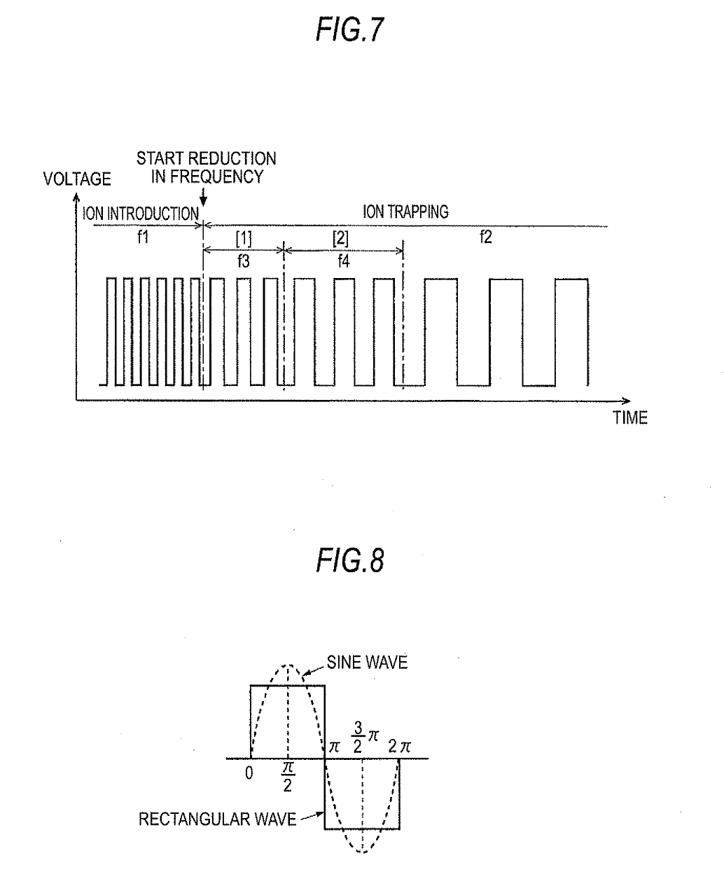

On the other hand, the RF voltage that is applied during the introduction of ions has no effect on the path of the ions with a high mass/charge ratio. This means that if the switch from a high-frequency f1 to a low-frequency f2 is performed instantaneously as shown in FIG. 4 without any intervening intermediate state, the ion trapping efficiency becomes substantially comparable to that of the ion-introduction-without-RF-application method. In contrast to this, if the frequency of the RF voltage is changed in a stepwise manner with one or more intermediate states (having a frequency between f1 and f2) as shown in FIG. 7 (FIG. 7 shows two intermediate states identified as 1 and 2), the trapping efficiency in the high mass/charge ratio region can be improved while simultaneously expanding the trappable mass/charge ratio range.

The reason for this is that in the introduction of the ions into ion trap 10 based on the effect of the DC electrical field, the time of flight of an ion increases as its mass/charge ratio increases. To further explain, if various ions are emitted from an ion supply source in the form of a pulse (i.e., substantially all at the same time), ions with a relatively low mass/charge ratio are introduced earlier into the ion trap 10 while ions with a high mass/charge ratio are delayed, meaning that there would be ions with a high mass/charge ratio that have not yet entered the ion trap 10 when the frequency of the RF voltage is switched. If an intermediate state is not provided when switching the frequency as shown in FIG. 4 or with the previous ion-introduction-without-RF-application method, ions having a high mass/charge ratio cannot easily enter the ion trap once ion trapping is started, thus making them untrappable in the ion trap. On the other hand, if the frequency of the RF voltage is reduced in a stepwise manner as shown in FIG. 7, the effect of the RF voltage on ions with a high mass/charge ratio when the frequency of the RF voltage is started to be changed is minimal, thus making it possible even for ions with a high mass/charge ratio and arriving late at the ion trap 10 to enter the ion trap 10. Because the frequency of the RF voltage is further reduced after the entry of such ions into the ion trap 10, the trapping is performed efficiently.

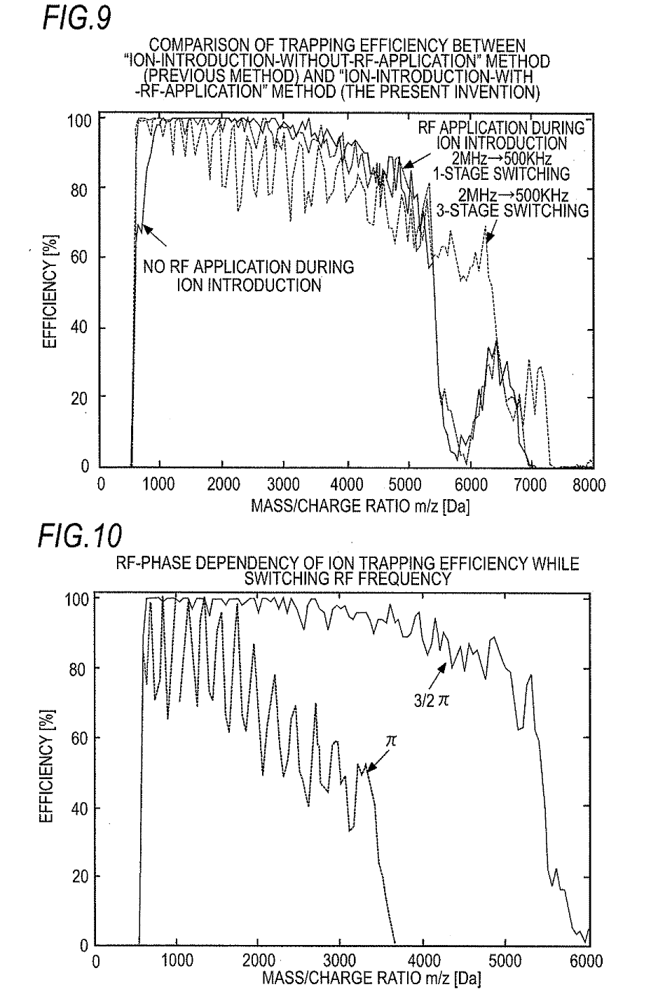

FIG. 9 is a plot of the trapping efficiency that was determined from a simulation of the path of ions each for every 50 Da increment in mass/charge ratio between 500 Da and 8000 Da. One hundred ions, each provided with random initial conditions, were analyzed for every 50 Da increment. With the “ion-introduction-with-RF-application” method where no intermediate state was provided (i.e., 1-step switching), the frequency f1 of the RF voltage at the time of ion introduction was set to 2 MHz, and the frequency f2 of the RF voltage at the time of ion trapping was set to 500 kHz. With the “ion-introduction-with-RF-application method, “the conditions were set so that when intermediate states were provided (i.e., 3-step switching), the same intermediate frequency was repeated 5 cycles each while reducing the frequency from f1 to f2 in 3 steps as follows: 2 MHz→1 MHz→667 kHz→500 kHz. The amplitude of the RF voltage was set to 1 kV in both cases. As an example, the LMCO for a frequency of 500 kHz is 548.8 Da.

As FIG. 9 shows, for a low mass/charge ratio region between 600 and 1000 Da, the ion trapping efficiency of the “ion-introduction-with-RF-application” method is significantly higher than that of the “ion-introduction-without-RF-application” method. Furthermore, even with the “ion-introduction-with-RF-application” method, for ions having a high mass/charge ratio of roughly between 5500 and 6500 Da, changing the frequency in a stepwise manner significantly increased the ion trapping efficiency as compared to the method where the frequency was changed instantaneously. These simulation results confirm that the “ion-introduction-with-RF-application” method according to the present invention is superior to the previous “ion-introduction-without-RF-application” method in terms of expanding the mass/charge ratio range.

If, as shown in FIG. 8, the phase of a rectangular wave (duty ratio of 50% in this case) is defined to be the same as that of a sine-wave waveform and the phase of the RF voltage is changed when the frequency is switched, the ion trapping efficiency changes depending on the mass/charge ratio. To trap positive ions, the usual practice is to switch the frequency of the RF voltage at the phase 3π/2 since this provides the best ion trapping efficiency. To trap ions over the widest range of mass/charge ratios and to do this with a high efficiency, the phase at which the RF voltage is switched should be set to 3π/2(or π/2 for negative ions). In contrast to this, the range of the trappable mass/charge ratio can be narrowed and ions having specific mass/charge ratios can be selectively trapped by intentionally shifting away the phase at which the RF voltage is switched from 3π/2 (π/2 for negative ions).

FIG. 10 shows the results of a simulation comparing the ion trapping efficiency when the phase for switching the frequency of the RF voltage is varied between 3π/2 and π for mass/charge ratios that were varied between 500 Da and 6000 Da in 50 Da increments. As FIG. 10 shows, if the frequency is switched at phase π, the range of trappable mass/charge ratio is narrowed to about one-half of that when the frequency is switched at phase 3π/2. The graph further shows that the ion trapping efficiency varies widely over the trappable mass/charge ratio range. This variation in trapping efficiency can be used to selectively trap specific ions by appropriately adjusting the phase for switching the frequency of the RF voltage to increase the trapping efficiency for specific mass/charge ratios.

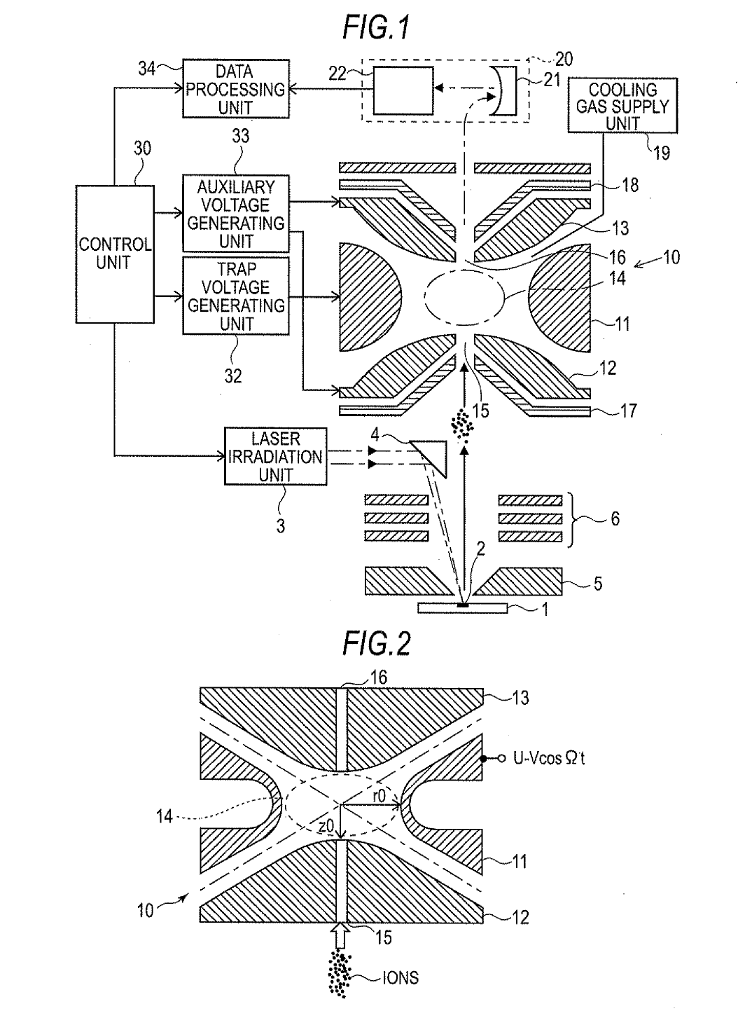

As described in Non-Patent Literature 1, witha digital ion trap, an electrical field compensation electrode is positioned outside the inlet-side end cap electrode 12, and a DC voltage is applied to the electrical field compensation electrode to compensate for the electrical field that is formed near the ion-entering orifice 15 (see FIG. 1). With the “ion-introduction-with-RF-application” method used by the present invention, if the electrical field compensation electrode is not used, then, even if the frequency of the RF voltage is changed at a phase that provides the most efficient ion trapping, the trapping efficiency would change wildly depending on the ion's mass/charge ratio. The cause for this is a noise voltage that is generated in end cap electrodes 12 and 13 by the RF voltage that is applied to the end cap electrodes 12 and 13.

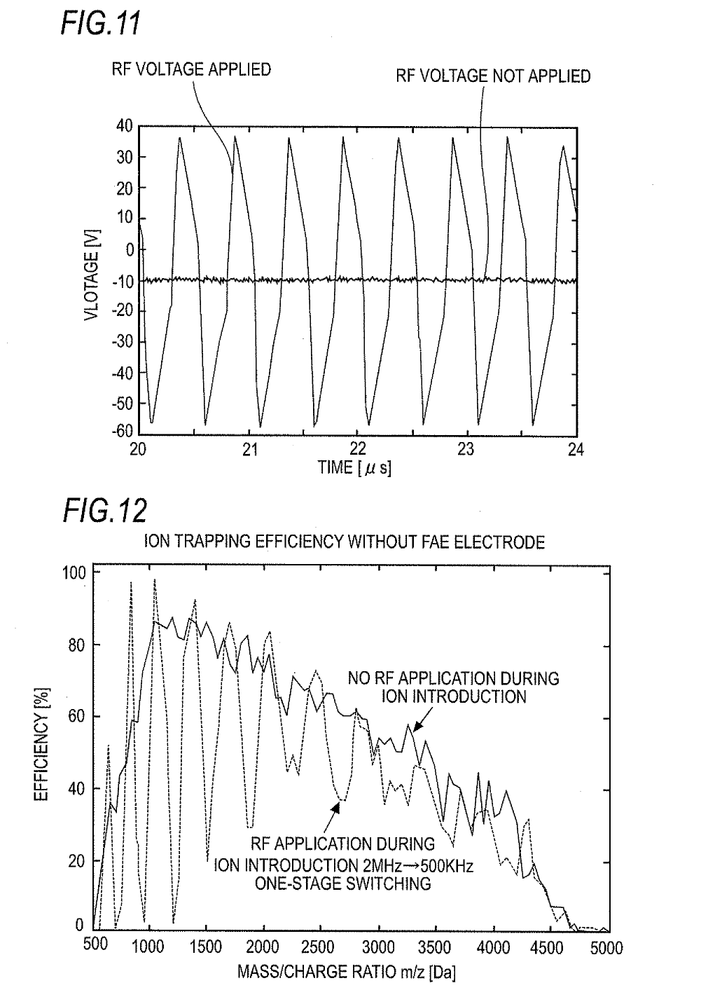

FIG. 11 shows the waveform of the noise voltage that was generated in end cap electrode 12 and measured on an oscilloscope when a rectangular, 2 MHz, 1 kV RE voltage was applied to ring electrode 11. When analyzing positive ions, a DC voltage of −10V is applied to the inlet-side end cap electrode 12 at the time of ion introduction. Because of this, when a RF voltage is not being applied to the ring electrode 11, the voltage of the end cap electrode 12 is substantially stable at −10 V. In contrast to this, when the afore-described RF voltage is applied, a noise voltage with an amplitude of approximately 45V is generated in the end cap electrode. Furthermore, since the period of the rectangular voltage that is applied to the ring electrode 11 is short, it can be seen that the next noise voltage is generated before the preceding noise voltage has been damped. The result is that the condition at the end cap electrode 12 is substantially similar to the application of a RF voltage with a waveform that is close to a sine-wave.

If, in addition to the afore-described condition, an electrical field compensation electrode is not provided, the velocity of the ions that arrive at the inlet-side end cap electrode 12 after being accelerated by the application of a voltage of several keV or more by the ion transport optical system in the previous stage would be very high. Depending on the timing with which the ions pass through the inlet-side end cap electrode 12 (i.e., depending on the phase of the noise voltage as the ions pass through the inlet-side end cap electrode), the kinetic energy of the ions after passing through the inlet-side end cap electrode varies greatly, resulting in ions to enter ion trap 10 with a large kinetic energy that make them difficult to be trapped by ion trap 10.

FIG. 12 shows the results of a simulation of calculated trapping efficiency when noise voltage with an amplitude of 50 V is generated in end cap electrode 12 in the absence of an electrical field compensation electrode. The afore-described results of simulations shown in FIG. 9, FIG. 10 and the like assume the presence of an electrical field compensation electrode to which an appropriate DC voltage is applied. Even with the “ion-introduction-without-RF-application” method, since the electrical field near the ion-entering orifice 15 changes, the trapping efficiency decreases when compared to the case where an electrical field compensation electrode is provided. On the other hand, with the “ion-introduction-with-RF-application” method, because the afore-described noise voltage creates dramatic changes in the electrical field near the ion-entering orifice 15, the change in trapping efficiency is also dramatic. The impact is particularly great with ions in the low mass/charge ratio range where a difference of approximately 200 Da creates a fluctuation in trapping efficiency between 0 and 100%. This result and the afore-described results show that providing an electrical field compensation electrode on the outside of the inlet-side end cap electrode 12 and applying a DC voltage to the electrical field compensation electrode reduce the effects of the noise voltage created by the RF voltage and improves the ion trapping efficiency as afore-described.

Also, even in the case where an electrical field compensation electrode is provided, if the voltage difference between the DC voltage that is applied to the inlet-side end cap electrode 12 and the DC voltage that is applied to the electrical field compensation electrode is increased (i.e., if the potential difference between the ion transport optical system in the preceding stage and the electrical field compensation electrode is reduced), the ions can pass through the inlet-side end cap electrode 12 without undergoing sufficient deceleration, thus increasing the effects of the noise voltage. The resulting effects are similar to the case where an electrical field compensation electrode is not provided, and as FIG. 12 shows, the ion trapping efficiency can be greatly changed depending on the mass/charge ratio. This effect allows the phase used in switching the frequency of the RF voltage to be used to even more precisely control the selective trapping of ions having specific mass/charge ratios. To explain, by combining the adjustment of the phase used in switching the frequency of the RF voltage and the adjustment of the DC voltage that is applied to the electrical field compensation electrode (i.e., by adjusting the afore-described voltage difference), it is possible to trap with a high selectivity only the ions having a specific single mass/charge ratio.

The foregoing explanation assumed the use of a RF voltage as the rectangular voltage that is used with the digital ion trap, but the waveform of the RF voltage does not matter so long as the frequency of the RF voltage can be rapidly changed, and the RF voltage can be, for example, triangular waves, sawtooth waves and the like.

Furthermore, even though, in the afore-described examples, the frequency of the RF voltage was changed while holding its amplitude constant, so long as the amplitude of the RF voltage can be quickly changed from a low-voltage to a high-voltage, the ion behavior can be similarly controlled by changing the amplitude instead of changing the frequency.

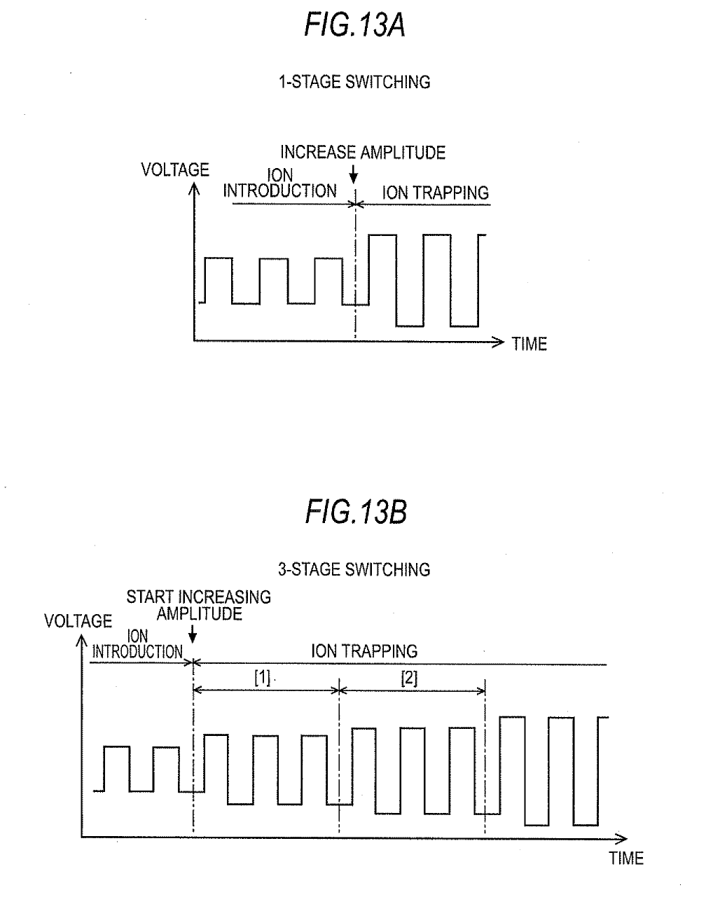

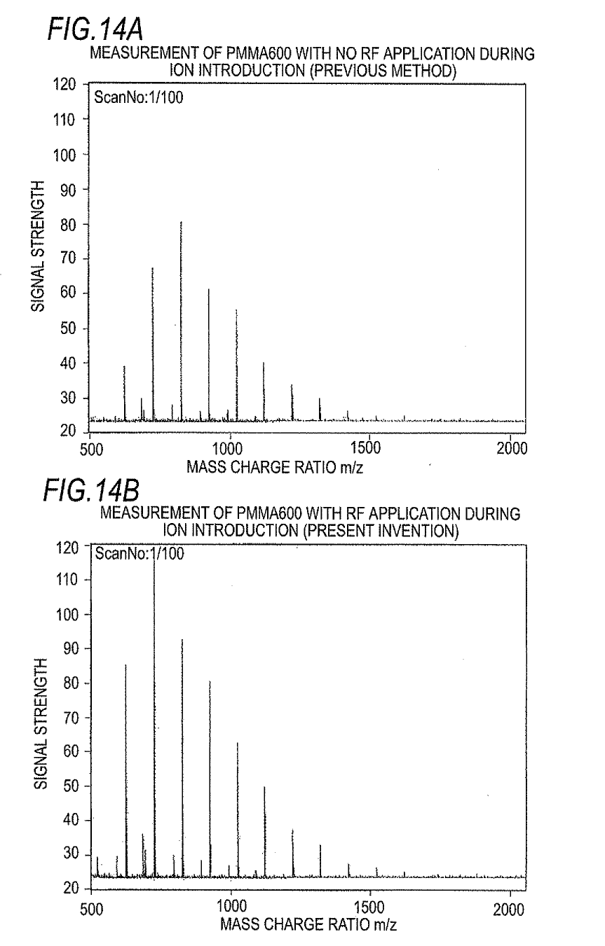

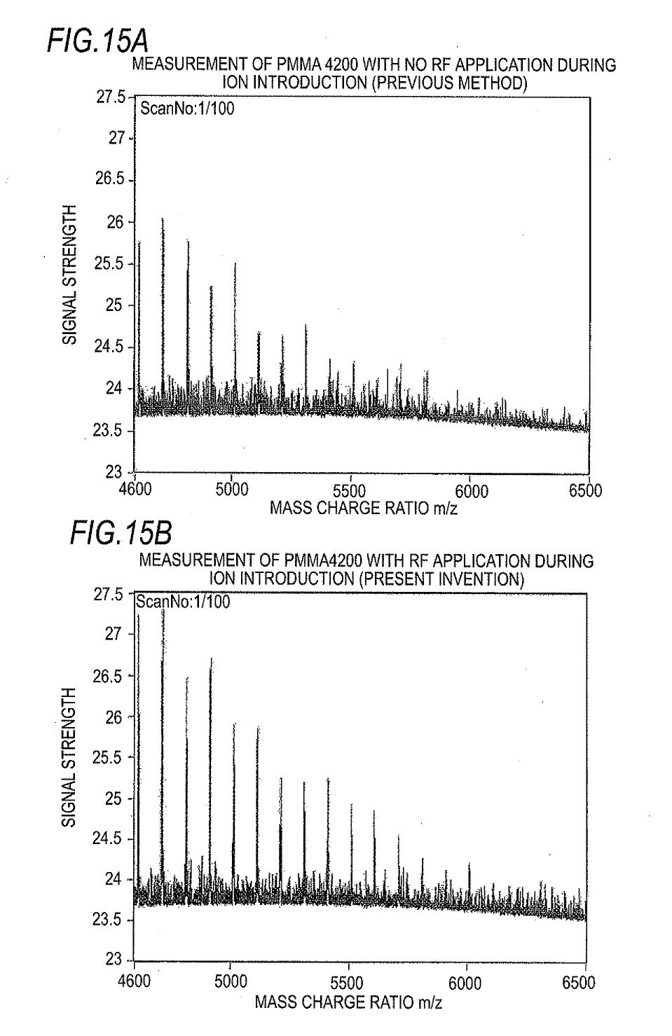

FIG. 13 shows one example of a waveform wherein changes in the amplitude of a rectangular voltage are used to improve ion introduction and ion trapping. As FIG. 13(a) shows, by applying a predetermined RF voltage of a low voltage to the ring electrode when introducing ions into the ion trap, the ions can be efficiently introduced into the ion trap, and by switching the RF voltage to a high-voltage immediately after the introduction of the ions into the ion trap, the ions that are introduced can be efficiently trapped. Also, as FIG. 13(b) shows, by changing the rectangular voltage so that the amplitude increases in a plurality of steps, the trapping efficiency can be improved even with ions belonging to the high mass/charge ratio region. Here, even though a rectangular wave voltage is shown, control that is based on changing the amplitude can be more easily implemented with analog ion traps than digital ion traps.

### Embodiments

The configuration and operation of one embodiment of the present invention as a matrix assisted laser dissociation ionization digital ion trap mass spectrometer (MALDI-DIT-MS) that employs an ion trap device that uses the afore-described ion introduction method are described next in detail. FIG. 1 shows the overall configuration of the embodiment as a MALDI-DIT-MS.

The ion trap 10 is the afore-described 3-dimensional quadrupole ion trap and includes one annular ring electrode 11 and a pair of end cap electrodes 12 and 13 (located at the top and bottom in FIG. 1) that is disposed to sandwich the ring electrode. An ion-entering orifice 15 is formed substantially at the center of the inlet-side end cap electrode 12, and an electrical field compensation electrode 17 is located outside of the ion-entering orifice 15 to correct the disturbance in electrical field near the ion-entering orifice 15. On the other side, an ion-exiting orifice 16 is formed substantially at the center of the outlet-side end cap electrode 13 along a substantially straight line from the ion-entering orifice 15. An extraction electrode 18 for extracting the ions toward the ion detector 20 is disposed outside of the ion-exiting orifice. A cooling gas supply unit 19 for supplying cooling gas (generally an inert gas) for cooling the ions in the ion trap 10 is also provided.

The MALDI ion source (equivalent to the ion supply source in the present invention) for generating the ions includes a laser irradiation unit 3 that irradiates a laser beam onto a sample 2 that is placed on a metallic sample plate 1 and a reflection mirror 4 that reflects and converges the laser beam onto the sample 2. Disposed between the sample plate 1 and the ion trap 10 are an aperture 5 for blocking dispersing ions and an Einzel lens 6 that serves as an ion transport optical system for transporting the ions to the ion trap 10. Needless to say, ion transport optical systems of configurations other than an Einzel lens 6 can be used, in particular, electrostatic lens optical systems.

On the other side, disposed on the outside of the ion-exiting orifice 16 is an ion detector 20 which includes a conversion dynode 21 for converting the ions into electrons and a secondary electron multiplier 22 for multiplying and detecting the converted electrons. The ion detector 20 allows the detection of both positive ions and negative ions. Detection signals from the ion detector 20 are input to the data processing unit 34 where the signals are converted to digital values and further data processed.

A rectangular voltage of a predetermined frequency from a trap voltage generating unit 32 (equivalent to the voltage applying means of the present invention) is applied to the ring electrode 11 of the ion trap 10, and a predetermined voltage (DC voltage or RF voltage) from an auxiliary voltage generating unit 33 is applied to each of a pair of end cap electrodes 12 and 13. The trap voltage generating unit 32, which, as described below, generates a rectangular wave voltage, can be configured by including, for example, a positive voltage generating unit for generating a predetermined positive voltage, a negative voltage generating unit for generating a predetermined negative voltage and a switching unit for rapidly switching between the positive voltage and the negative voltage for generating a rectangular voltage. The control unit 30 (equivalent to the control means in the present invention), which is configured to include a CPU, etc., controls the operation of the trap voltage generating unit 32, auxiliary voltage generating unit 33 and the laser irradiation unit 3.

The basic measurement operations with the embodiment as a MALDI-DIT-MS are as described next. A laser beam is emitted to the sample 2 for a short duration from a laser irradiation unit 3 under the control of a control unit 30. The matrix within the sample 2 is rapidly heated by the laser irradiation and is vaporized including the target component. The target component is ionized during this process. The ions that are generated pass through the aperture 5 and are converged by an electrostatic field that is formed by the Einzel lens 6 as the ions are transported towards the ion trap 10 and into the ion trap 10 through the ion-entering orifice 15. Because the irradiation time with the laser beam is very short, the generation time of the ions is also very short, short enough to consider that various ions are emitted in the form of a pulse. The various ions arrive at the ion-entering orifice in the form of a group to some extent.

A trap voltage generating unit 32 applies a rectangular RP voltage with a frequency of f1 and voltage amplitude of V to the ring electrode 11 until a predetermined amount of time t1 has elapsed starting from either the laser irradiation timing from the laser irradiation unit 3 or some point in time prior to that. Then, starting from when the predetermined amount of time t1 has elapsed, the frequency of the RF voltage is reduced (i.e., the period is increased) in three steps using a predetermined number of intervening cycles between the steps until, ultimately, a rectangular voltage with a voltage amplitude of V and a frequency of f2 is applied. Also, when the ions are entering the ion trap 10, the auxiliary voltage generating unit 33 applies to the inlet-side end cap electrode 12 a predetermined DC voltage (or, alternatively, 0 volt) of a polarity opposite of that of the ions being analyzed and applies to the outlet-side end cap electrode 13 an appropriate DC voltage of the same polarity as that of the ions being analyzed.

The aforesaid predetermined time t1 is set so that its elapse happens immediately after at least some of the ions that are emitted from the sample 2 by laser irradiation have passed through the ion-entering orifice 15 and have been introduced into the ion trap 10. The time required from the laser irradiation timing to the arrival of ions at the ion trap 10 depends on such factors as the flight distance of the ions and their flight speed and cannot be unilaterally determined and must be determined experimentally or by simulation calculations. Here, as an example, t1 is set to 15 μs. The frequency of the RF voltage f1 at the time of ion introduction is 2 MHz, and the final frequency of the RF voltage 12 when the ions are trapped is, for example, 500 kHz. However, it is desirable for 12 to be changed depending on the mass/charge ratio of the ions being analyzed. The amplitude V of the RF voltage is fixed to 1 kV. For ions spanning a broad mass/charge ratio range that are introduced into the ion trap 10 to be trapped well, it is necessary for the time required in changing the frequency of the RF voltage from f1 to f2 to be less than a predetermined time, and that time determines the number of repeating cycles per frequency that will be used in reducing the frequency in a stepwise manner. This point is further elaborated below.

Prior to the introduction of the ions, a cooling gas such as helium and the like is introduced into the ion trap 10 from the cooling gas supply unit 19. When the ions that enter the ion trap 10 through ion-entering orifice 15 while applying a voltage as afore-described to electrodes 11, 12 and 13 come close to the ion-exiting orifice 16, the ions are repelled by the electrical field that is formed by the DC voltage that is applied to the outlet-side end cap electrode 13 and return toward the trap region 14. As afore-described, the frequency of the RF voltage is high (small value of q) when the ions are introduced into the ion trap 10. The frequency of the RF voltage that is applied to the ring electrode 11 is then decreased in a stepwise manner starting from immediately after the introduction of ions into the ion trap 10. As afore-described, both ions that belong in the low mass/charge ratio side and ions that belong in the high mass/charge ratio side are introduced into and are trapped by ion trap 10 with high efficiency. Furthermore, the ions that are introduced into the ion trap 10 would initially have a comparatively high kinetic energy but the kinetic energy is gradually lost (i.e., cooled) through collision with the cooling gas that is present in the ion trap 10 and becomes more easily trapped by the trapping electrical field.

After cooling for an appropriate amount of time (e.g., approximately 100 ms) to stably trap the ions in the trap region 14, a RF signal of a predetermined frequency is applied by an auxiliary voltage generating unit 33 to end cap electrodes 12 and 13 while applying the rectangular voltage to the ring electrode 11. This causes a resonant excitation (excitation) of ions having a specific mass/charge ratio. For example, a signal that is obtained by frequency division of the rectangular voltage that is applied to the ring electrode 11 may be used as the RF signal. The excited ions having a specific mass/charge ratio are discharged from the ion-exiting orifice 16 and are introduced into the ion detector 20 where they are detected, thus preforming the mass separation and detection of the ions. By appropriately scanning the frequency of the rectangular voltage that is applied to the ring electrode 11 and the frequency of the RF signal that is applied to the end cap electrodes 12 and 13, the mass/charge ratio of the ions that are discharged from the ion trap 10 through the ion-exiting orifice 16 is scanned. By sequentially detecting the ions with the ion detector 20, the data processing unit 34 prepares a mass spectrum.

An embodiment as a MALDI-DIT-MS that uses such a mass spectrum is described next.

FIG. 14 shows actually measured mass spectra obtained using the “ion-introduction-without-RF-application” method (previous method) and the “ion-introduction-with-RF-application” method (the present invention) on a standard specimen of PMMA 600. This is an embodiment where the mass/charge ratio of the ion that is analyzed is low. With either method, the frequency f2 of the RF voltage when trapping the ions is 524 kHz (LMCO:500). With the “ion-introduction-with-RF-application” method, the frequency is changed every 10 cycles in 3 steps as follows: 2 MHz (f1)→1 MHz→667 kHz→524 kHz (f2). This means that the time required in changing the frequency of the RF voltage from f1 to f2 is 25 μs. During this time, the amplitude of the RF voltage is kept constant at 1 kV. The DC voltage that is applied to sample plate 1, inlet-side end cap electrode 12 and outlet-side end cap electrode 13 is 5V, −5V and 20 V, respectively, with the “ion-introduction-without-RF-application” method and is 8 V, −10 V and 25 V, respectively, with the “ion-introduction-with-RF-application” method.

With an ideal measurement of the PMMA600, the signal strength has a normal distribution about 600 Da at the center with peaks detected every 100 Da. However, with the graph shown in FIG. 14(a), the signal strength peaks around 800 Da, and it is clear that ion trapping efficiency is lower at 600 or 700 Da. In comparison to that, with the graph shown in FIG. 14(b), the signal strength is the highest at 700 Da, and the peak occurring at 600 Da is also more than twice as strong as the peak in FIG. 14(a). Furthermore, although weak, a peak that is attributed to 500 Da ions is also detected. Based on the afore-described, the results of actual measurements have also confirmed that the “ion-introduction-with-RF-application” method improves the trapping efficiency of ions in the low mass/charge ratio range close to LMCO.

FIG. 15 shows the actual mass spectra measured with the “ion-introduction-without-RF-application” method (previous method) and the “ion-introduction-with-RF-application” method (the present invention) on a standard specimen of PMMA4200. This is an embodiment wherein the mass/charge ratio of the ions that are analyzed is high. With these measurements, the frequency f2 of the RF voltage when trapping the ions is 380 kHz (LMCO:950). With the “ion-introduction-with-RF-application” method, the frequency is changed every 10 cycles in 3 steps as follows: 2 MHz (f1)→1 MHz→667 kHz→380 kHz (f2). This means that the time required in changing the frequency of the RF voltage from f1 to f2 is 25 μs, the same as that for the afore-described PMMA 600. The amplitudes of the RF voltage and the DC voltage that were applied to sample plate 1 and end cap electrodes 12 and 13 were the same as those used with PMMA 600.

Since the mass range that is shown in FIG. 15 covers 4600 Da or more and belongs to the higher end of the distribution for PMMA 4200, the signal strength is weak, and the S/N ratio is poor, but it is clear that the signal strength of all peaks is higher with the “ion-introduction-with-RF-application” method than the “ion-introduction-without-RF-application” method shown in FIG. 15(a). These experimental results confirm that the “ion-introduction-with-RF-application” method, which provides intermediate steps when changing the frequency, improves the trapping efficiency of not just ions having a low mass/charge ratio but also ions having a high mass/charge ratio.

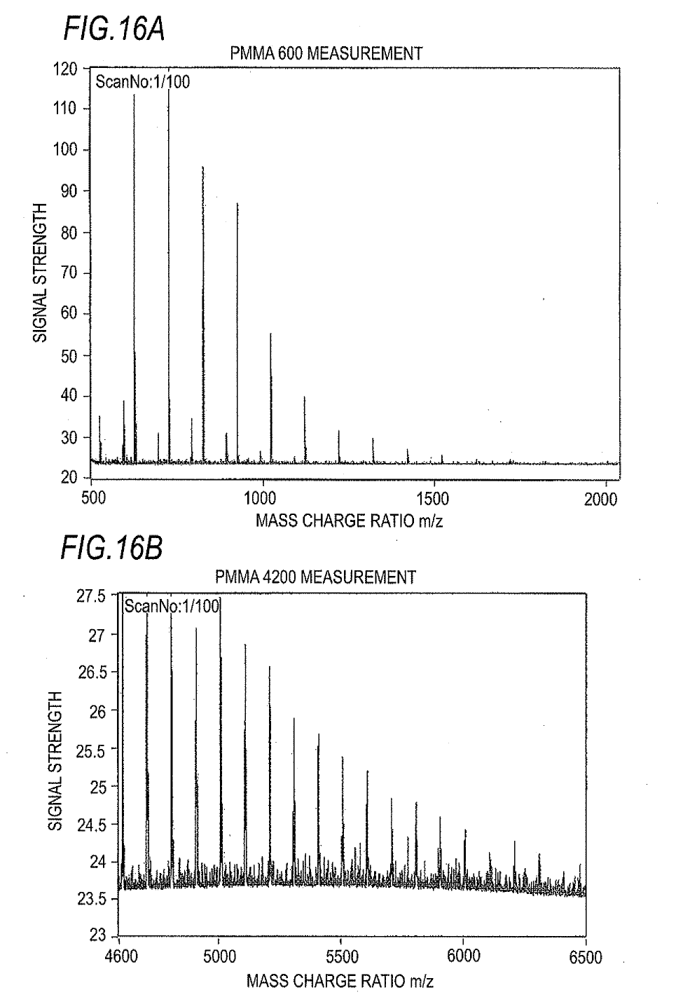

FIG. 16 shows the actual mass spectra, which were obtained, when the number of repeating cycles for a given frequency when changing the frequency of the RF voltage with the “ion-introduction-with-RF-application” method from f1 to f2 was increased by two-fold from 10 cycles to 20 cycles. This means that the time required in changing the frequency of the RF voltage from f1 to f2 was extended to 50 μs. A comparison of FIG. 16(a) and (b) against FIG. 14(b) and FIG. 15(b) shows that the mass spectra that are obtained are of a comparable quality, thus showing that extending the time spent in changing the frequency of the RF voltage after introduction of ions into the ion trap 10 to about 50 μs still does not change the superiority over the previous ion introduction method in terms of trapping efficiency in the low mass/charge ratio region and the high mass/charge ratio region.

According to experiments conducted by the inventors in this application, even when the time spent in changing the frequency of the RF voltage after the introduction of ions into the ion trap 10 is extended to about 100 μs, improvements can be expected in trapping efficiency in the high mass/charge ratio region over the previous “ion-introduction-without-RF-application” method.

The afore-described embodiments are just examples of the present invention, and needless to say, various additions, corrections and modifications can be made to the embodiments without deviating from the thrust of the present invention and the scope of the claims of the present invention.

1. An ion trap device comprising:
an ion supply source for supplying ions in the form of a pulse; and
an ion trap that uses an electrical field that is formed in a space surrounded by a plurality of electrodes to trap ions that are supplied by said ion supply source; and
further comprising:
(a) a voltage applying means for applying an AC voltage to at least one of a plurality of electrodes constituting said ion trap so as to trap the ions in said ion trap; and
(b) a control means that controls said voltage applying means so that immediately after the introduction into said ion trap of ions that are supplied in the form of a pulse from said ion supply source while applying an AC voltage having a predetermined first frequency to one of a plurality of electrodes, the frequency of said AC voltage is changed within a predetermined amount of time to a second frequency of a lower frequency than the first frequency,
wherein said control means controls said voltage applying means to change the frequency in a stepwise manner every cycle or every plurality of cycles from a first frequency to a second frequency while keeping the amplitude of said AC voltage constant.

2. (canceled)

3. (canceled)

4. (canceled)

5. (canceled)

6. The ion trap device according to claim 1, wherein said ion trap is a 3-dimensional quadrupole ion trap comprising a ring electrode and a pair of end cap electrodes that sandwich said ring electrode and said voltage applying means applies an AC voltage to said ring electrode.

7. The ion trap device according to claim 6 wherein said AC voltage is a rectangular voltage.

8. The ion trap device according to claim 6 wherein an opening through which ions pass and an electrical field compensation electrode to which a DC voltage is applied are formed outside of the end cap electrode in which an ion-entering orifice is formed.

9. The ion trap device according to claim 7 wherein, in switching the frequency of said AC voltage immediately after the introduction of ions into said ion trap, said control means shifts the phase of the AC voltage when switching by 3π/2 if the subject of the analysis is positive ions and by π/2 if the subject of the analysis is negative ions so that ions having a specific mass/charge ratio are efficiently trapped by said ion trap.

10. The ion trap device according to claim 8 further comprising a compensation voltage adjustment means for adjusting the DC voltage that is applied to said electrical field compensation electrode so as to increase the potential difference with respect to the DC voltage that is applied to an inlet-side end cap electrode and thereby efficiently trap ions having a specific mass/charge ratio with said ion trap.

11. An ion trap device comprising:
an ion supply source for supplying ions in the form of a pulse; and
an ion trap that uses an electrical field that is formed in a space surrounded by a plurality of electrodes to trap ions that are supplied by said ion supply source; and
further comprising:
(a) a voltage applying means for applying an AC voltage to at least one of a plurality of electrodes constituting said ion trap so as to trap the ions in said ion trap; and
(b) a control means that controls said voltage applying means so that immediately after the introduction into said ion trap of ions that are supplied in the form of a pulse from said ion supply source while applying an AC voltage having a predetermined first amplitude to one of a plurality of electrodes, the amplitude of said AC voltage is changed within a predetermined amount of time to a second amplitude of a greater amplitude than the first amplitude,
wherein said control means controls said voltage applying means to change the frequency in a stepwise manner every cycle or every plurality of cycles from a first frequency to a second frequency while keeping the amplitude of said AC voltage constant.
